(19) United States
(12) Patent Application Publication
(10) Pub. No.: US 2011/0234657 A1
(43) Pub. Date: Sep. 29, 2011

(54) Inkjet head assembly

(75) Inventors: Jae Hun Kim, Seoul (KR); Won Chul Sim, Seongnam (KR); Young Seuck Yoo, Seoul (KR); Jae Woo Joung, Suwon (KR)

(73) Assignee: Samsung Electro-Mechanics Co., Ltd., Suwon (KR)

(21) Appl. No.: 12/926,646

(22) Filed: Dec. 1, 2010

(30) Foreign Application Priority Data
Mar. 24, 2010 (KR) 10-2010-0026260

(51) Int. Cl. B41J 2/195; B41J 2/175

(52) U.S. Cl. 347/7; 347/85

(57) ABSTRACT

There is provided an inkjet head assembly that can readily store ink by separating a passage for transferring ink from a passage for transferring ink between a first storage unit and a second storage unit inside an ink tank. An inkjet head assembly according to an aspect of the invention may include: an ink tank including a first storage unit receiving ink therein and a second storage unit receiving the ink from the first storage unit to maintain a full ink level within the ink, and having an ink transfer hole, through which the ink is supplied from the first storage unit to the second storage ink, and an air transfer hole, through which air from the second storage unit is transmitted to the first storage unit, between the first and second storage units; and an inkjet head connected to the second storage unit via an ink supply passage, the inkjet head receiving the ink from the second storage unit to eject the ink.

### CROSS-REFERENCE TO RELATED APPLICATIONS

This application claims the priority of Korean Patent Application No. 10-2010-0026260 filed on Mar. 24, 2010, in the Korean Intellectual Property Office, the disclosure of which is incorporated herein by reference.

### BACKGROUND OF THE INVENTION

1. Field of the Invention

The present invention relates to an inkjet head assembly, and more particularly, to an inkjet head assembly that can readily store ink by separating a passage for transferring ink from a passage for transferring ink between a first storage unit and a second storage unit inside an ink tank.

2. Description of the Related Art

An image forming apparatus develops a black and white image or a color image on a recording medium such as paper according to an image signal. Examples of the image forming apparatus may include laser printers, inkjet printers, copying machines, multifunction printers, and facsimiles. An image forming method of an image forming apparatus may include an electrophotographic method and an inkjet method. According to an electrophotographic method, beams are scanned onto a photosensitive material to form an electrostatic latent image, and a developing agent is adhered thereto, which is then transferred to a recording medium. According to an inkjet method, liquefied ink is transferred onto the surface of a printing medium according to an image signal.

An inkjet image forming apparatus includes an inkjet head spraying ink according to an image signal. The inkjet head ejects ink droplets onto a recording medium according to an image signal to thereby print a character or a picture onto a recording medium. Since the inkjet image forming apparatus makes relatively low noise during printing and forms droplets with high density, the inkjet image forming apparatus has come into widespread use for printing.

One type of inkjet image forming apparatus includes an inkjet head receiving ink from an ink tank, which is formed integrally with the inkjet head or is detachably connected thereto, a carriage scanning the inkjet head in a predetermined direction relative to a recording medium, and a transfer device transferring the inkjet head in a direction (negative scanning) perpendicular to the predetermined direction. The inkjet image forming apparatus forms an image by ejecting ink during the scanning of the inkjet head.

As for the inkjet head of the inkjet image forming apparatus, there are a shuttle type print head and a so-called array inkjet head. A shuttle type print head is separated by a predetermined interval from the surface of a recording medium being transferred and ejects ink while reciprocating in a direction (a widthwise direction of the recording medium) perpendicular to a direction in which the recording medium is transferred. An inkjet head has a length corresponding to the width of the recording medium and enables line printing. The array inkjet head can print one line at a time to thereby achieve high-speed printing.

The above-described shuttle type inkjet head or array inkjet head is supplied with ink from an ink tank storing ink. When the inkjet head is transferred by the transfer device during the printing process, a change in pressure may occur due to the slopping of the ink stored in the ink tank. To this end, a storage unit of the ink tank, in which ink is stored, is divided into first and second storage units, and the second storage unit is formed between the first storage unit and the inkjet head to thereby prevent deterioration in printing quality cased by the slopping of the ink occurring during the transferring process. However, it is difficult to transmit the ink from the first storage unit to the second storage unit due to an increase in pressure generated from the inside of the second storage unit.

### SUMMARY OF THE INVENTION

An aspect of the present invention provides an inkjet head assembly that can readily store ink by separating a passage for transferring ink from a passage for transferring ink between a first storage unit and a second storage unit inside an ink tank.

According to an aspect of the present invention, there is provided an inkjet head assembly including: an ink tank including a first storage unit receiving ink therein and a second storage unit receiving the ink from the first storage unit to maintain a full ink level within the ink, and having an ink transfer hole, through which the ink is supplied from the first storage unit to the second storage ink, and an air transfer hole, through which air from the second storage unit is transmitted to the first storage unit, between the first and second storage units; and an inkjet head connected to the second storage unit via an ink supply passage, the inkjet head receiving the ink from the second storage unit to eject the ink.

The ink transfer hole and the air transfer hole may be formed at different heights.

The air transfer hole may be formed at a position higher than that of the ink transfer hole.

The ink transfer hole and the air transfer hole may each have a diameter of 1 mm to 10 mm.

A filter may be provided in the ink supply passage.

The inkjet head may include an ink chamber temporarily receiving the ink supplied by the second storage unit.

The inkjet head may include an inkjet discharge passage through which the ink, supplied by the second storage unit, is discharged.

The first storage unit may include a pneumatic port and an ink injection port.

The first storage unit may have a sensor mounted thereon in order to measure an ink level.

The sensor may be mounted on an upper part or a side part of the first storage unit.

The sensor may include a first sensor measuring a minimum ink level within the ink to be received in the first storage unit and a second sensor measuring a maximum ink level thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating the configuration of an inkjet head assembly according to an exemplary embodiment of the present invention.

### DETAILED DESCRIPTION OF THE PREFERRED EMBODIMENT

Exemplary embodiments of the present invention will now be described in detail with reference to the accompanying drawings.

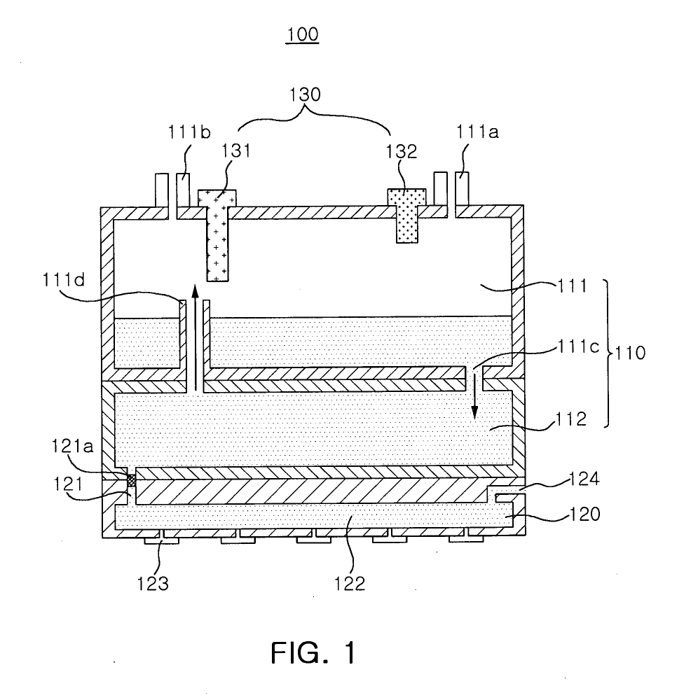

FIG. 1 is a schematic view illustrating the configuration of an inkjet head assembly according to an exemplary embodiment of the present invention.

Referring to FIG. 1, an inkjet head assembly 100 according to this embodiment includes an ink tank 110 receiving ink and an inkjet head 120 receiving the ink from the ink tank 110 and ejecting the ink onto a recording medium to thereby form an image.

In the specification of the present invention, the term “recording medium” refers to various kinds of ink receptive objects, such as cloth, plastic film, metallic sheets, glass, ceramics, and wood, as well as paper.

The ink tank 110 includes a first storage unit 111 receiving ink and a second storage unit 112 connected to the first storage unit 111. The second storage unit 112 is supplied with the ink from the first storage unit 111 and supplies the ink to the inkjet head 120. The second storage unit 112 maintains a full ink level within the ink and supplies the ink to the inkjet head 120 while the second storage unit 112 maintains the full ink level within the ink.

An ink transfer hole 111c through which the ink is supplied from the first storage unit 111 to the second storage unit 112 or an air transfer hole 111d through which air from the second storage unit 112 is transmitted to the first storage unit 111 may be formed between the first storage unit 111 and the second storage unit 112 of the ink tank 110. Each of the ink transfer hole 111c and the air transfer hole 111d may have a diameter of 1 mm to 10 mm. However, the present invention is not limited thereto.

The inkjet head 120 is connected to the second storage unit 112 via an ink supply passage 121. The inkjet head 120 receives the ink from the second storage unit 112 to thereby eject the ink. A filter 121a may be formed inside the ink supply passage 121. The ink being supplied to the inkjet head from the ink tank 110 needs to be kept clean and free of foreign matter. The ingress of foreign matter, such as dust, may cause a blockage in nozzles 123 inside the inkjet head. As a result, ink ejection may not be appropriately performed.

The inkjet head 120 has an ink chamber 122 at a top surface thereof so as to temporarily receive the ink being supplied from the second storage unit 112. The inkjet head 120 also has the plurality of nozzles 123 at a bottom surface thereof so as to eject the ink.

Furthermore, the inkjet head 120 has an ink discharge passage 124 connected to one side of the ink tank in order to discharge the ink from the ink chamber 122 to the outside.

The inkjet head assembly undergoes a change in pressure due to the slopping of the ink stored inside the ink tank while being transferred by a transfer device (not shown) during the printing process. This adversely affects the speed and volume of droplets being ejected through the inkjet head, thereby deteriorating printing quality. However, according to this embodiment, the ink tank 110, provided in order to supply the ink to the inkjet head 120, is divided into the first storage unit 111 and the second storage unit 112, and the second storage unit 112, directly connected to the inkjet head 120, is supplied with the ink through the ink transfer hole 111c from the first storage unit 111 to thereby maintain the full ink level within the ink. That is, when the inkjet head assembly operates, a change in pressure, caused by the slopping of the ink, is attenuated by the second storage unit 112, thereby minimizing deterioration in printing quality.

Meanwhile, when the full ink level within the ink is maintained by transferring the ink from the first storage unit 111 to the second storage unit 112 through the ink transfer hole 111c, the transfer of the ink can be facilitated by easily discharging air present in the second storage unit 112. Thus, the air transfer hole 111d is formed between the first storage unit 111 and the second storage unit 112.

That is, while the ink is being transferred from the first storage unit 111 to the second storage unit 112 through the ink transfer hole 111c, air present in the second storage unit 112 is transmitted to the first storage unit 111 through the air transfer hole 111d. As described above, while the ink is being transferred to the second storage unit 112, in order to transmit the air present in the second storage unit 112 to the first storage unit 111 through the air transfer hole 111d, the ink transfer hole 111c and the air transfer hole 111d may be formed at different heights. Preferably, the air transfer hole 111d may be formed at a position higher than that of the ink transfer hole 111c so that the outflow of air can be facilitated in the early stage of ink injection when the ink is introduced.

The inkjet head is supplied with the ink from the ink tank. When an excessive amount of ink is supplied during the printing process or if ink is supplied even when printing is not performed, wetting may occur, that is, ink can be ejected through the surface of the inkjet head regardless of the printing process. In order to prevent this, there is a need to create negative pressure between the inkjet head and the ink tank so that movement of the ink occurs between the ink tank and the inkjet head only when ink is sprayed.

Therefore, the first storage unit may have a pneumatic port 111b formed between the inkjet had and the ink tank in order to create negative pressure between the inkjet head and the ink tank.

Furthermore, during the image-forming process, when the ink level within the ink, received in the first storage unit 111, drops below a predetermined minimum ink level, an ink injection port 111a may be formed in the first storage unit 111 so that ink can be injected from the ink reservoir through the ink injection port 111a.

Hereinafter, the operation of the inkjet head assembly will be described.

In general, an inkjet head assembly has an ink tank and an inkjet head that are formed into a single body or are detachable from each other. An inkjet head assembly having an inkjet tank and an inkjet head detachable from each other is mounted on a transfer system (not shown) capable of moving the inkjet head assembly to a recording medium. After the ink tank is first mounted on the transfer system, the inkjet head is then coupled with the ink tank.

As the inkjet head assembly is mounted on the transfer system (not shown) and moves along a printing surface of the recording medium, the inkjet jet head assembly ejects ink through the nozzles 123 to thereby form an image.

Here, when ink is supplied from the ink tank 110 to the inkjet head 120, in order to prevent the supply of the ink with bubbles, ink, supplied to the inkjet head 120, may be discharged through the ink discharge passage 124 for a predetermined period of time in the early stage when ink is supplied.

As described above, the ink tank 110 includes the first storage unit 111 and the second storage unit 112, and the second storage unit 112, directly connected to the inkjet head 120, supplies ink to the inkjet head 120 while the full ink level is maintained. Therefore, a change in pressure, caused by the slopping of the ink while the inkjet head assembly is transferred during the printing process, is not made, thereby enhancing printing quality.

During the image-forming process, when the ink level within the ink, received in the first storage unit 111, drops below a predetermined minimum ink level, the ink can be injected through the ink injection port 111a, formed in the first storage unit 111, from the ink reservoir.

As described above, even when ink is supplied to the first storage unit 111 and the second storage unit 112 due to the consumption of the ink during printing, a change in pressure can be effectively attenuated.

Furthermore, when the ink is transmitted to the second storage unit 112 from the first storage unit 111 through the ink transfer hole 111c, in order to maintain the full ink level, the air transfer hole 111d is formed between the first storage unit 111 and the second storage unit 112 to thereby discharge air present in the second storage unit 112, thereby facilitating the transfer of the ink from the first storage unit 111 to the second storage unit 112.

Meanwhile, in this embodiment, the first storage unit 111 may include a sensor 130 in order to measure an ink level. In order to maintain the full ink level within the ink to be received in the second storage unit from the first storage unit, it is important to maintain the ink level of the first storage unit at a predetermined level or higher. That is, an ink level is measured using the sensor mounted on the first storage unit lest the ink level of the first storage unit is lower than that of the second storage unit, thereby controlling the amount of ink being injected from the ink reservoir.

The position of the sensor 130 measuring the ink level is not particularly limited. For example, the sensor 130 may be mounted on the upper part of the first storage unit 111. The sensor 130 may include a first sensor 131 measuring a minimum ink level within the ink to be received in the first storage unit 111 and a second sensor 132 measuring a maximum ink level thereof.

When the ink, received in the first storage unit 111, drops below a predetermined minimum ink level, the sensor 130 senses this and causes ink to be supplied through an ink injection port. When the ink level is higher than the predetermined ink level, the sensor 130 senses this and causes the supply of ink to be stopped.

Furthermore, though not shown in FIG. 1, the sensor 130 measuring the ink level may be formed at the side of the first storage unit 111.

As set forth above, according to exemplary embodiments of the invention, ink is readily stored by separating a passage for transferring ink from a passage for transferring air between a first storage unit and a second storage unit inside an ink tank, so that ink flowing into the first storage unit can be easily transferred to the second storage unit.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head assembly comprising:
an ink tank including a first storage unit receiving ink therein and a second storage unit receiving the ink from the first storage unit to maintain a full ink level within the ink, and having an ink transfer hole, through which the ink is supplied from the first storage unit to the second storage ink, and an air transfer hole, through which air from the second storage unit is transmitted to the first storage unit, between the first and second storage units; and
an inkjet head connected to the second storage unit via an ink supply passage, the inkjet head receiving the ink from the second storage unit to eject the ink.

2. The inkjet head assembly of claim 1, wherein the ink transfer hole and the air transfer hole are formed at different heights.

3. The inkjet head assembly of claim 2, wherein the air transfer hole is formed at a position higher than that of the ink transfer hole.

4. The inkjet head assembly of claim 1, wherein the ink transfer hole and the air transfer hole each have a diameter of 1 mm to 10 mm.

5. The inkjet head assembly of claim 1, wherein a filter is provided in the ink supply passage.

6. The inkjet head assembly of claim 1, wherein the inkjet head comprises an ink chamber temporarily receiving the ink supplied by the second storage unit.

7. The inkjet head assembly of claim 1, wherein the inkjet head comprises an inkjet discharge passage through which the ink, supplied by the second storage unit, is discharged.

8. The inkjet head assembly of claim 1, wherein the first storage unit comprises a pneumatic port and an ink injection port.

9. The inkjet head assembly of claim 1, wherein the first storage unit has a sensor mounted thereon in order to measure an ink level.

10. The inkjet head assembly of claim 9, wherein the sensor is mounted on an upper part or a side part of the first storage unit.

11. The inkjet head assembly of claim 9, wherein the sensor comprises a first sensor measuring a minimum ink level within the ink to be received in the first storage unit and a second sensor measuring a maximum ink level thereof.
